(19) United States
(12) Patent Application Publication
(10) Pub. No.: US 2020/0043031 A1
(43) Pub. Date: Feb. 6, 2020

(54) Systems and Methods for Generating and Executing Online Interactive Multimedia Challenges During Online Transactions

(71) Applicant: Activision Publishing, Inc., Santa Monica, CA (US)

(72) Inventor: Josiah Eatedali, Los Angeles, CA (US)

(21) Appl. No.: 16/527,724

(22) Filed: Jul. 31, 2019

Related U.S. Application Data
(60) Provisional application No. 62/713,494, filed on Aug. 1, 2018.

(51) Int. Cl. G06Q 30/02

(52) U.S. Cl. CPC G06Q 30/0209; G06Q 30/0222; G06Q 30/0239; G06Q 30/0253; G06Q 30/0277; G06Q 30/0255

(57) ABSTRACT

The disclosed systems and methods integrate gaming functionality, and associated rewards, with on-line advertising. Systems for integrating online interactive multimedia challenges into advertising and electronic transactions include a host computer that provides an on-line advertisement with a graphical user interface having a purchase option and a challenge engagement option, receives data indicative of whether the user selected the purchase option or the challenge engagement option, generates graphical user interfaces for completing a purchase transaction or the challenge depending on the selected option, and, based on the outcome of the challenge, generates a different purchase option than before, preferably with improved purchasing terms if the user successfully completes the challenge.

### CROSS-REFERENCE

The present application relies on U.S. Patent Provisional Application No. 62/713,494, entitled “Systems and Methods for Generating and Executing Online Interactive Multimedia Challenges During E-Commerce Transactions” and filed on Aug. 1, 2018, for priority and is hereby incorporated by reference in its entirety.

### FIELD

The present specification relates to systems and methods configured to generate online interactive multimedia challenges embedded in advertising. More particularly, the present specification relates to systems and methods that integrate online interactive multimedia challenges, configured as online communications or advertisements, with electronic transactions.

### BACKGROUND

E-commerce is a highly competitive industry where goods and services are offered for sale online via the Internet. Most often, the same goods and services are available on multiple competitor e-commerce websites or marketplaces. As a result, e-commerce businesses are constantly looking at ways to differentiate themselves in terms of the consumer experience on their online marketplaces.

Online advertising has also flourished along with the explosive growth in e-commerce. However, consumers visiting an e-commerce website are often passive towards online advertisements (displayed on the webpages of the website or as pop-up ads) since they are too focused in browsing the product or service and consider these advertisements nuisances or distractions.

There is a need to integrate relevant online advertising with e-commerce transactions to provide a richer, more fun, and more intriguing consumer experience and to increase consumer engagement and attract consumers toward online advertisements that are configured to offer a relevant and potentially rewarding outcome in the context of an e-commerce transactions. There is also a need for e-commerce businesses to engage online customers in ways that differentiate them from their competitors.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a computer implemented method for generating and executing online interactive multimedia challenges during electronic transactions, the method being implemented in a host computer having one or more physical processors programmed with computer program instructions that, when executed by the one or more physical processors, cause the host computer to perform the method, the method comprising: providing an on-line advertisement comprising a first graphical user interface having a first option associated with a first purchase offer of a product or service and a second option associated with engaging in a challenge; receiving, at the host computer, data indicative of whether the user selected the first option or the second option; using the host computer, generating a plurality of second graphical user interfaces if the data is indicative of the user selecting the first option, wherein the plurality of second graphical user interfaces are configured to receive billing information and to complete a purchase transaction; and using the host computer, generating a third graphical user interface comprising the challenge if the data is indicative of the user selecting the second option.

Optionally, the computer implemented method further comprises monitoring the user's engagement with the challenge and generating a second purchase offer based on an outcome of said challenge, wherein the second purchase offer is different than the first purchase offer.

Optionally, using the host computer, the challenge is generated based on the user's browsing history.

Optionally, using the host computer, the challenge is generated based on the user's login ID.

Optionally, the third graphical user interface challenge is configured as a downloadable executable that, if activated by the user, allows the user to engage with the challenge.

Optionally, the third graphical user interface challenge is configured as a scripted advertisement that, if activated by the user, allows the user to engage with the challenge.

Optionally, the computer implemented method further comprises, using the host computer, directing the user to a game server if the user interacts with the third graphical user interface.

Optionally, the computer implemented method further comprises monitoring, by the host computer, the user's gameplay, interactions, and performance data and communicating the user's gameplay, interactions, and performance data to a game server for storing in a game database system.

Optionally, the computer implemented method further comprises using a challenge module in the host computer, determining if the user's performance data meets or exceeds one or more predetermined targets associated with the challenge.

Optionally, the computer implemented method further comprises, using the challenge module, determining that the performance data meets or exceeds one or more predetermined targets associated with the challenge and, in response, generating a second purchase offer, wherein the second purchase offer is different than the first purchase offer.

The present specification also discloses a system for generating and executing online interactive multimedia challenges during electronic transactions, said system comprising: a host computer having one or more physical processors programmed with computer program instructions that, when executed, cause the host computer to: provide an on-line advertisement comprising a first graphical user interface having a first option associated with a first purchase offer of a product or service and a second option associated with engaging in a challenge; receive data indicative of whether the user selected the first option or the second option; generate a plurality of second graphical user interfaces, wherein the plurality of second graphical user interfaces are configured to receive billing information and to complete a purchase transaction; and generate a third graphical user interface comprising said challenge if the data is indicative of the user selecting the second option.

Optionally, when executed, the computer program instructions further cause the host computer to monitor the user's engagement with the challenge and generate a second purchase offer based on an outcome of said challenge, wherein the second purchase offer is different than the first purchase offer.

Optionally, when executed, the computer program instructions further cause the host computer to generate the challenge based on the user's browsing history.

Optionally, when executed, the computer program instructions further cause the host computer to generate the challenge based on the user's login ID.

Optionally, the third graphical user interface challenge is configured as a downloadable executable that, if activated by the user, allows the user to engage with the challenge.

Optionally, the third graphical user interface challenge is configured as a scripted advertisement that, if activated by the user, allows the user to engage with the challenge.

Optionally, when executed, the computer program instructions further cause the host computer to direct the user to a game server if the user interacts with the third graphical user interface.

Optionally, when executed, the computer program instructions further cause the host computer to monitor the user's gameplay, interactions, and performance data and communicate the user's gameplay, interactions, and performance data to a game server for storing in a game database system.

Optionally, when executed, the computer program instructions further cause the host computer to use a challenge module to determine if the user's performance data meets or exceeds one or more predetermined targets associated with the challenge.

Optionally, when executed, the computer program instructions further cause the host computer to use the challenge module to determine that the performance data meets or exceeds one or more predetermined targets associated with the challenge and, in response, generate a second purchase offer, wherein the second purchase offer is different than the first purchase offer.

The aforementioned and other embodiments of the present specification shall be described in greater depth in the drawings and detailed description provided below.

### BRIEF DESCRIPTION OF THE DRAWINGS

These and other features and advantages of the present specification will be further appreciated, as they become better understood by reference to the following detailed description when considered in connection with the accompanying drawings:

FIG. 1 illustrates an exemplary system environment for providing online interactive multimedia challenges or advertisements during electronic transactions, in accordance with some embodiments of the present specification;

FIG. 2A shows an exemplary first GUI screen displaying a product and/or service along with a plurality of challenge elements, in accordance with an embodiment of the present specification;

FIG. 2B shows an exemplary second GUI screen illustrating a rendering of the interactive multimedia game as an interface embedded within the screen webpage, in accordance with an embodiment of the present specification;

FIG. 2C shows an exemplary third GUI screen illustrating a reward statement on successful completion of a challenge, in accordance with an embodiment of the present specification; and,

FIG. 3 is a flowchart illustrating an exemplary process for implementing an interactive multimedia challenge or advertisement in the context of an electronic transaction, in accordance with an embodiment of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

As used herein, the indefinite articles “a” and “an” mean “at least one” or “one or more” unless the context clearly dictates otherwise.

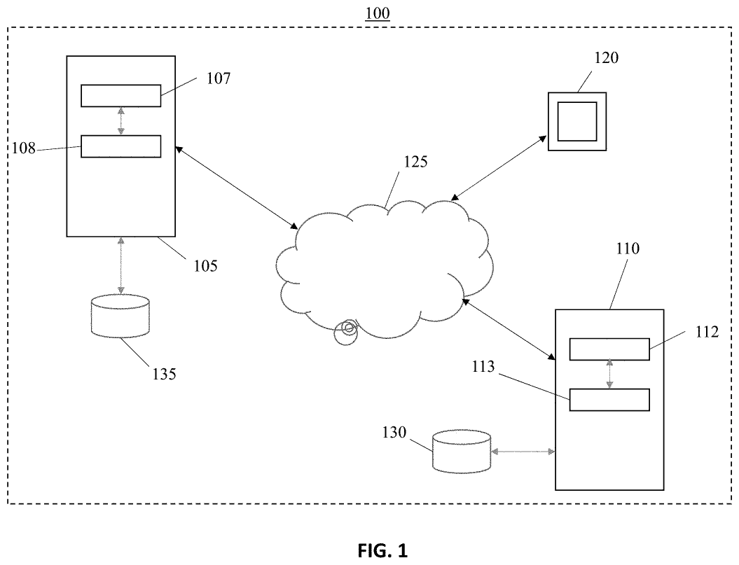

FIG. 1 illustrates an exemplary system environment 100 for providing online interactive multimedia games, challenges, and/or advertisements during electronic transactions, in accordance with some embodiments of the present specification. The environment 100 comprises at least one web server 105, at least one game server 110, and at least one client device 120 all in data communication with each other through a network 125.

The servers 105, 110 can be any computing device having one or more processors and one or more computer-readable storage media such as RAM, hard disk or any other optical or magnetic media. The servers 105, 110 include a plurality of hardware, software, and/or firmware components operating together to provide or implement a plurality of functional, operational or service-oriented modules.

In some embodiments, the game server 110 includes or is in communication with a game database system 130. The game database system 130 stores game data associated with at least one interactive multimedia game, such as a video game, that is served or provided to the client devices 120 over the network 125 on request by a user. In some embodiments, the game server 110 may be implemented by a cloud of computing platforms operating together as game servers 110. In some instances, the game server 110 may be associated with a proprietary gameplay network system, such as, without limitation, SONY PLAYSTATION NETWORK, MICROSOFT XBOX LIVE, and/or another type of gameplay network system. In this implementation, a given client device 120 may be associated with a particular type of gaming console. Other types of client devices 120 using other types of gameplay networks may be used as well.

In some embodiments, the web server 105 includes or is in communication with an electronic transaction database system 135. In some embodiments, the electronic transaction database system 135 stores at least one schema of a plurality of challenge data associated with a plurality of products and/or services that are displayed, served or provided to the client devices 120 over the network 125 via one or more GUIs (Graphical User Interfaces). In accordance with an aspect of the present specification, the plurality of challenge data includes one or more universal resource locators (URLs), pointing to one or more interactive multimedia games (stored in the game database system 130). In some embodiments, the web server 105 may be implemented by a cloud of computing platforms operating together as web servers 105.

The client device 120 may be configured as a handheld gaming device, a personal computer (for example, a desktop computer, a laptop computer), a smartphone, a tablet computing device, a smart television, a personal assistant device such as Amazon Alexa or Google Home, and/or other device that can be used to interact with an instance of an interactive multimedia challenge. The client device 120 may include one or more processors, one or more storage devices, one or more peripherals, and/or other components. The processors may be programmed by one or more computer program instructions. The various computer program instructions may be stored in a storage device which may comprise random access memory (RAM), read only memory (ROM), and/or other memory. The storage device may store the computer program instructions to be executed by the processor as well as data that may be manipulated by the processor. The storage device may comprise floppy disks, hard disks, optical disks, tapes, or other storage media for storing computer-executable instructions and/or data.

The network 125 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The various database systems 130, 135 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. A blockchain may also be used. The database may comprise one or more such databases that reside in one or more physical devices and in one or more physical locations. The database may store a plurality of types of data and/or files and associated data or file descriptions, administrative information, or any other data.

In some embodiments, the at least one web server 105 provides or implements a plurality of modules, such as, but not limited to, a trading module 107, and a challenge module 108. In some embodiments, the at least one game server 110 provides or implements a plurality of modules, such as, but not limited to, a game module 112 and a performance module 113. It should be appreciated that the term ‘module’ refers to computer logic utilized to provide a desired functionality, service or operation. In various embodiments, a module can be implemented in hardware, firmware and/or software controlling a general purpose processor. In one embodiment, the modules are programmatic codes or computer executable instructions stored on a storage system, such as the game and transaction database systems 130, 135, and executed by a processor.

In embodiments, the trading module 107 is configured to display or present to the user, via at least one graphical user interface (GUI), a plurality of electronic transaction related data associated with one or more products and/or services. For example, the plurality of electronic transaction related data may comprise product and/or service descriptions, price, quantities in stock, version or model numbers, time to dispatch and/or delivery or any other information as would be evident to those of ordinary skill in the art. In embodiments, the plurality of electronic transaction related data is stored in the transaction database system 135.

In embodiments, the challenge module 108 is configured to display or present to the user, via at least one GUI, at least one challenge associated with the product and/or service being displayed to the user at any instance. In various embodiments, the challenge is configured in the form of an interactive multimedia advertisement and comprises a plurality of challenge elements such as, but not limited to, a challenge-reward protocol description, at least one textual, graphical and/or multimedia teaser, punch line or commercial, at least one icon (such as, but not limited to, a ‘play’ or a ‘challenge accepted’ button) to solicit the user's response of acceptance of the challenge, and the challenge data associated with the product and/or service which is stored in the electronic transaction database system 135. As mentioned earlier in the specification, the challenge data includes one or more universal resource locators (URLs), pointing to one or more interactive multimedia games (stored in the game database system 130). In embodiments, the plurality of challenge elements, corresponding to a plurality of products and/or services, are stored in the electronic transaction database system 135 and accessible to the challenge module 108.

In some embodiments, the challenge data associated with the product and/or service has a characteristic relationship with and/or is tailored or customized to the nature, form, class, category, kind or type of the associated product, service and/or intended user. As non-limiting examples:
If the product and/or service is a book or pertains to reading, then the challenge data may be a crossword quiz or puzzle game or Sudoku game;
If the product and/or service is more specifically a book related to finance, business or economics, then the challenge data may be a video game adaptation of a board game, such as Monopoly®.
If the product and/or service is more specifically a book related to travel, then the challenge data may be a mini-video game adaptation of a game such as, L.A. Noire.
If the product and/or service is a basketball video game, basketball clothing, basketball tickets, or basketball sporting goods, the challenge data may be a video game offering at least one of a free-throw shooting challenge, three-point shooting challenge, timed shooting challenge, or one-on-one play challenge.
If the product and/or service is a baseball video game, baseball clothing, baseball tickets, or baseball sporting goods, the challenge data may be a video game offering at least one of a pitching challenge or batting challenge.
If the product and/or service is a football video game, football clothing, football tickets, or football sporting goods, the challenge data may be a video game offering at least one of a field goal kicking challenge, throwing challenge, or catching challenge.
If the product and/or service is a soccer video game, soccer clothing, soccer tickets, or soccer sporting goods, the challenge data may be a video game offering at least one of a goal kicking challenge, one-on-one challenge, or goal keeping challenge.
If the product and/or service is a hockey video game, hockey clothing, hockey tickets, or hockey sporting goods, the challenge data may be a video game offering at least one of a goal shooting, goal keeping or one-on-one challenge.
If the product and/or service is a tennis video game, tennis clothing, tennis tickets, or tennis sporting goods, the challenge data may be a video game offering at least one of a serving, volleying, or one-on-one challenge.

The challenge-reward protocol description, in some embodiments, indicates to the user details of a challenge and of a reward corresponding to successful completion of the challenge. For example, in some embodiments, the challenge is in the form of an interactive multimedia game that may be a puzzle, mini-video game, time-bound video game (that is, a video game that must be played and won within the constraints of a predetermined time), board game, multiplayer online game, first person shooter game, arcade game, action and adventure game, casino game, card game, strategy game, shooting game, sport game, and simulation. As non-limiting examples, the reward may be in the form of a discount on a displayed price of the product and/or service, an exclusive invitation to buy the displayed product and/or service (that may be available for buying only as a result of the user completing the challenge) at a predefined date/time, a privilege to buy a particular model, version or color of the product and/or service, one or more free or discounted add-ons such as, but not limited to, extended warranties, upgrade(s), repair/maintenance, spare parts, in-game items, skills, upgrades, and other in-game benefits, and other ancillaries that may be associated with the product and/or service, and free or discount coupons to movies, sports events, and theaters.

In some embodiments, a single challenge and a single associated reward is offered to the user. In some embodiments, the challenge and the associated reward may be multi-tiered. For example, in a first tier, completion of a first challenge may unlock a first reward for the user. Further, in a second tier, the user may be provided with an invitation to take a second challenge, which if completed successfully, may unlock a second reward for the user. In embodiments, a difficulty level of the challenges may increase with each tier and the attractiveness or perceived value of the rewards may also increase with each tier. In some embodiments, at least two challenges and respective two rewards may be offered to the user.

For example, a user who is reviewing surfboards, being displayed on a graphical user interface by the trading module 107, may be presented with multi-tiered challenges and associated rewards. The challenge data associated with the surfboard product may be a mini-video game adaptation of a surfing game such as, for example, Subway Surfers™ or any other surfing game known to persons of ordinary skill in the art. For example, in a first tier, a first challenge may correspond to the user (player) being able to find and collect a predefined number of trophies scattered throughout the game space while surfing large waves. Successful completion of the first challenge may be associated with a predefined amount or percentage discount, as a first reward. At successful completion of the first tier, the user is presented with the discount reward. The user may accept the first reward and, in a second tier, either choose to accept a second challenge for an associated second reward, which may be displayed to the user on at least one graphical user interface, or forego the second challenge.

The second challenge may correspond to the user (player) being able to gain a predefined number of points from performing tricks while surfing. Successful completion of the second challenge may be associated with another predefined amount or percentage discount as a second reward that may be higher than the one in the first reward or, alternatively, may comprise a free offer of a surf accessory such as, for example, an arch bar, body-board bag or fin hardware. It should be appreciated that the second reward is designed to be more lucrative and of a higher perceived value than the one in the first reward.

Accordingly, in one embodiment, the first challenge presented to a user has a first virtual landscape and a first set of gaming objectives which, if achieved, would result in the system generating a first communication linked to at least one of a first service offer, product offer, or discount. Upon completion of the first challenge and generation of the first communication, the system may then permit the user to respond to the first communication and/or be presented with a second challenge that has a second virtual landscape (which is the same as or different from the first virtual landscape) and a second set of gaming objectives (that are the same as or different from the first set of gaming objectives) which, if achieved, would result in the system generating a second communication linked to at least one of a second service offer, product offer, or discount, where the second service offer, product offer, or discount is the same as or different from the first service offer, product offer, or discount.

Upon completion of the second challenge and generation of the second communication, the system may then permit the user to respond to the second communication and/or be presented with a third challenge that has a third virtual landscape (which is the same as or different from the first and/or second virtual landscapes) and a third set of gaming objectives (that are the same as or different from the first set and/or second set of gaming objectives) which, if achieved, would result in the system generating a third communication linked to at least one of a third service offer, product offer, or discount, where the third service offer, product offer, or discount is the same as or different from the first and/or second service offer, product offer, or discount.

Upon completion of the third challenge and generation of the third communication, the system may then permit the user to respond to the third communication and/or be presented with a fourth challenge that has a fourth virtual landscape (which is the same as or different from the first, second and/or third virtual landscapes) and a fourth set of gaming objectives (that are the same as or different from the first, second and/or third set of gaming objectives) which, if achieved, would result in the system generating a fourth communication linked to at least one of a fourth service offer, product offer, or discount, where the fourth service offer, product offer, or discount is the same as or different from the first, second and/or third service offer, product offer, or discount.

In embodiments, the game module 112 is configured to execute an instance of an online interactive multimedia game which is displayed on the user's client device 120 to facilitate interaction of the user with the game. The game module 112 controls aspects of the game for the user and receives and processes the user's interactions in the game. In other words, the game module 112 hosts and renders the online game for the user, receives game data from the client device 120 and transmits updates to the client device 120 based on the received game data so that the game, on the client device 120, represents the most updated or current status with reference to interactions of the user with the game.

In embodiments, the online interactive multimedia game is rendered, displayed or presented to the user in any one of a first, second or third interactive interface. The first interactive interface corresponds to the online interactive multimedia game being rendered, displayed or presented to the user as an interface embedded within a webpage on the user's client device 120. In such embodiments, the first interactive interface is implemented as a rich internet application using tools (that enable interactivity along with a functionality to communicate the user's interactions and outcomes to the game server 110) such as, but not limited to, Adobe Flash, WebGL, JavaScript, Java Applet, ActiveX, and Curl.

The second interactive interface corresponds to the online interactive multimedia game being rendered, displayed or presented to the user as a video playback on a native media player on the client device 120. In such embodiments, a plurality of client-side program instructions (for example, using JavaScript) may be utilized to control and monitor the user's interaction with the game.

The third interactive interface corresponds to the online interactive multimedia game being rendered or presented to the user through a downloadable executable file (client-side component) which when activated (post download on the client device 120) operates as a gaming application that provides the user with an interactive interface between the user and the game. In embodiments, the gaming application is in data communication with the game module 112 that controls the virtual environment of the gaming application and acquires the user interactions with the game rendered through the gaming application.

It should be appreciated that the first, second and third interactive interfaces are exemplary and in no way limiting.

The interactive interfaces, for rendering the online interactive multimedia game, capture and process user inputs and interactions within the virtual environment and provide updates to the game server 110 over the network 125. In embodiments, the game module 112 captures and stores (in the game database system 130) a plurality of performance or outcome data generated as a result of the user's interactions with the virtual environment of the game. The performance data is communicated back or uploaded to the game server 110 in real-time or periodically (such as through batch updates) during a game and/or at an end of the game.

The performance module 113 accesses the stored performance data from the game database system 130 and communicates the performance data to the challenge module 108 (that is, the web server 105) on completion of the challenge(s) by the user. The challenge module 108, on receipt of the performance data, presents or displays the accessed performance data, via one or more GUIs, to the user as well as determines and implements a corresponding reward for the user—if the user opts to buy the product and/or service. It should be appreciated that, in some embodiments, the reward is realizable for the user subject to the user opting to buy the product and/or service.

During an exemplary implementation of the system environment 100, the user uses the client device 120 to access, via the network 125, an electronic transaction website that is hosted and managed from the web server 105. In some embodiments, the user is a registered member on the website. The website may display one or more products and/or services that are available for purchase by the user. In embodiments, when the user, while browsing the website, initiates a request for a web page, detailing at least one product and/or service, the user's request is received by the trading and challenge modules 107, 108 at the web server 105. As a result of the request, the trading module 107 queries the electronic transaction database system 135 to gather all electronic transaction related data associated with the product and/or service. The challenge module 108 also queries the electronic transaction database system 135 to gather at least one challenge, comprising a plurality of challenge elements, associated with the product and/or service. The electronic transaction related data and the challenge elements are assembled on a GUI screen or web page that is communicated by the web server 105 to the client device 120 for display to the user.

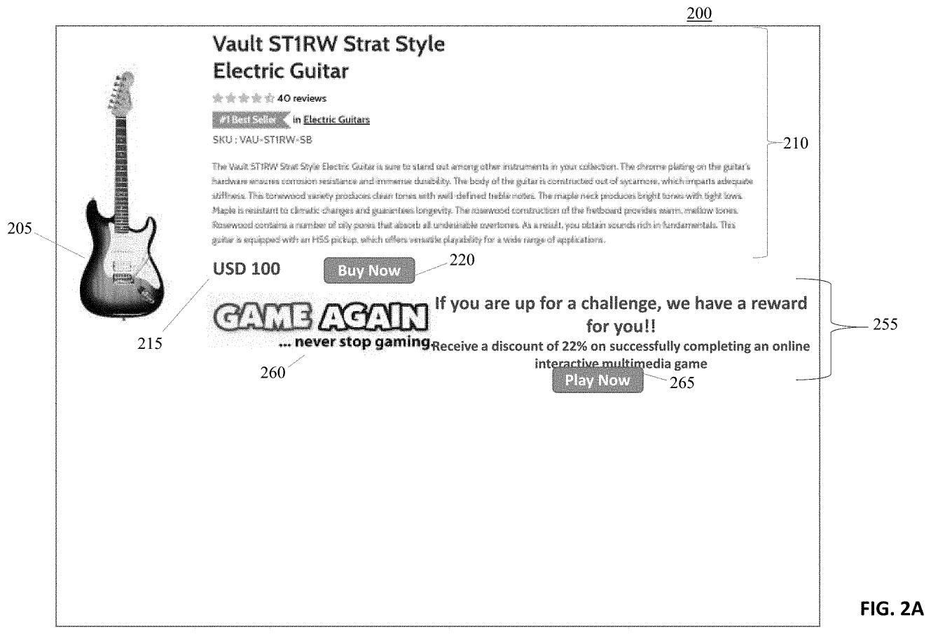

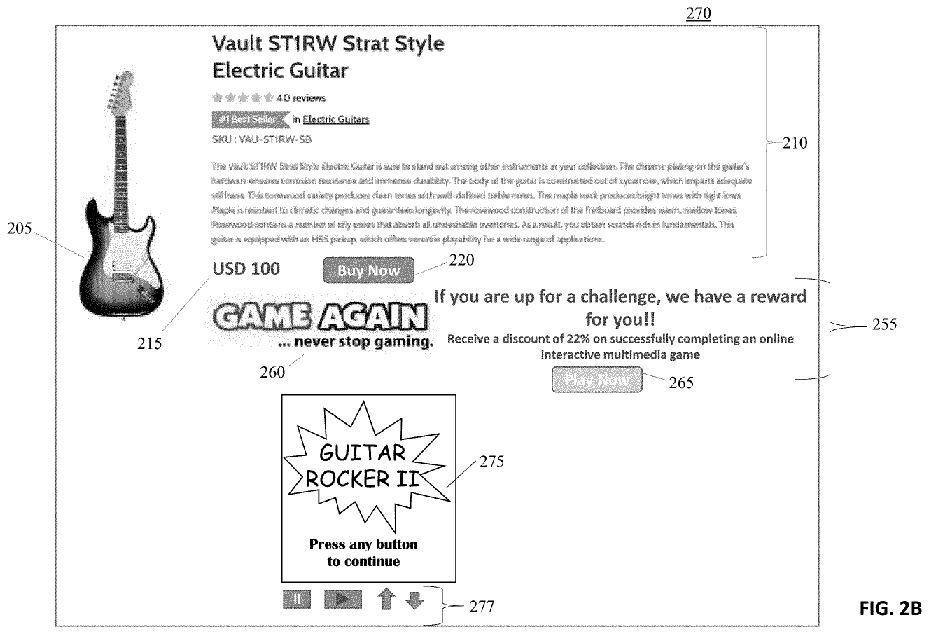

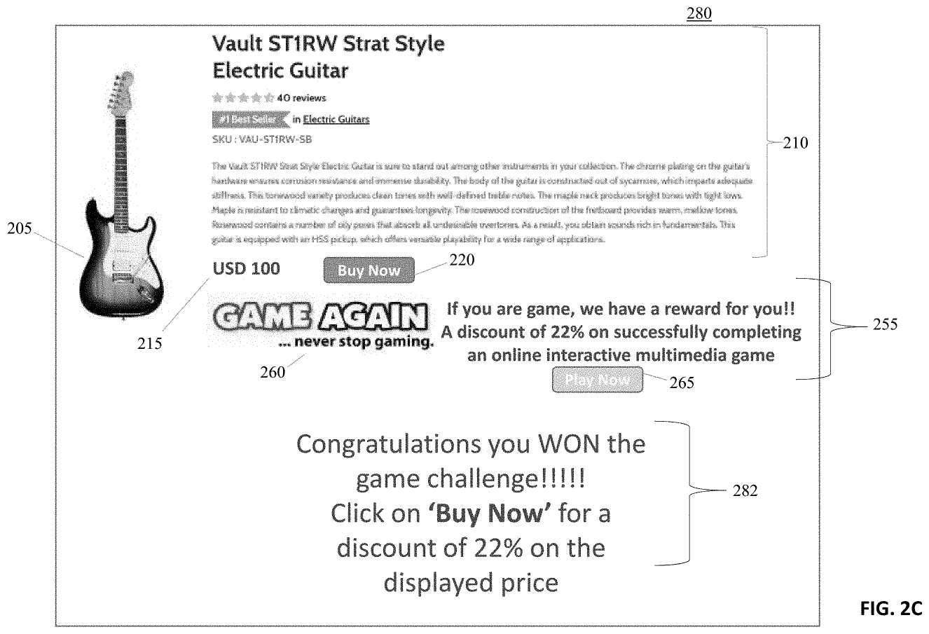

FIG. 2A shows an exemplary first GUI screen 200 displaying a product and/or service along with a plurality of challenge elements, in accordance with an embodiment of the present specification. The first screen 200 shows a plurality of electronic transaction related data such as, but not limited to, an optional image 205 corresponding to the product and/or service, a description 210 of the product and/or service, a tag price 215 at which the product and/or service can be purchased by the user, and a ‘buy’ button 220 that the user may click to initiate a purchase transaction. Also displayed on the first screen 200 are a plurality of challenge elements such as, but not limited to, a challenge protocol description 255 which may optionally include reward information, an optional textual, graphical and/or multimedia teaser, punch line or commercial 260, a ‘play’ button 265 which when clicked allows the user to accept the challenge description 255. Additionally, challenge data, associated with the product and/or service, is passed to the screen 200 at the level of the HTML script corresponding to the ‘play’ button 265. As mentioned earlier in the specification, the challenge data includes a URL, pointing to one or more interactive multimedia games (stored in the game database system 130). In some embodiments, reward information is not presented to the user until successful completion of the game.

If the user clicks the ‘play’ button 265, the underlying URL is activated as a result of which a request is sent to the game server 110 for an interactive multimedia game. The request for the interactive multimedia game is received by the game module 112 that fetches the corresponding game data (stored in the game database system 130) and renders the interactive multimedia game to the client device for display to the user in the form of any one of the first, second and third interactive interfaces.

FIG. 2B shows an exemplary second GUI screen 270 illustrating rendering of the interactive multimedia game as an interface embedded within the screen 270 webpage, in accordance with an embodiment of the present specification. The screen 270 shows an interface 275 that displays or renders the interactive multimedia game for the user. In some embodiments, the interface 275 displays a plurality of action buttons 277 that enable the user to interact with the interface 275. Additionally or alternatively, the user may interact with the interface 275 using any other input device such as controllers, keyboards, mice, etc. The screen 270 also shows the plurality of electronic transaction related data and challenge elements as described earlier with reference to FIG. 2A. In some embodiments, the ‘play’ button 265 is deactivated (shown as a blurred button) while the user plays the interactive multimedia game. In some embodiments, the user is allowed to play the game for a predetermined number of attempts (such as, but not limited to, 3 attempts) and therefore, the ‘play’ button 265 is reactivated to allow for subsequent play attempts by the user.

The user's performance data, representing the outcome of user's playing the game, is communicated to the game module 112 for storing in the game database system 130. Subsequently, the performance module 113 communicates the performance data to the challenge module 108. The challenge module 108 determines if the user's performance data is a ‘success’ or a ‘failure’. If the user's performance data is determined to be a successful completion of the challenge/game, the challenge module 108 communicates a commensurate reward to the user on a GUI screen. In some embodiments, the reward is dynamic and commensurate with the user's level of completion of the challenge. For example, in a kill zombie challenge, if a user successfully kills 5 out of 10 zombies in the challenge, the user may receive a 5% discount on the item as a reward. If, however, the user successfully kills 10 out of 10 zombies, the user may receive a 10% discount on the item as a reward. It should be appreciated that the rewards may also be non-financial or non-monetary such as, for example, early access to a new product release, branded items and accessories (such as, for example, T-shirts, hand gloves, and joy sticks), access to special products, services, or SKUs (Stock Keeping Units), and in-game virtual items and/or benefits, such as, for example, skins, weapons, and/or levels.

Accordingly, in one embodiment, the communication which occurs at the completion of a challenge may be linked to a degree of gaming success in the challenge, wherein the gaming success is determined by at least one of a number of points scored, number of enemies killed, amount of treasure obtained, amount of health retained, number of levels passed, distance traveled, speed of completion, finishing order of a race and wherein a greater amount of points scored, enemies killed, treasure obtained, health retained, levels passed, distance traveled or a faster speed of completion would receive a different communication than a lesser amount of points scored, enemies killed, treasure obtained, health retained, levels passed, distance traveled or a slower speed of completion.

FIG. 2C shows an exemplary third GUI screen 280 illustrating a reward statement that is presented upon successful completion of a challenge, in accordance with an embodiment of the present specification. Screen 280 also shows the plurality of electronic transaction related data and challenge elements as described earlier with reference to FIG. 2A. Note that the ‘play’ button 265 is deactivated (blurred) on completion of the game. The screen 280 shows an exemplary reward statement 282. In some optional embodiments, the screen 280 also displays the user's performance data. In some embodiments, the user may view the reward only if the user opts to buy the product and/or service. Accordingly, if the user clicks the ‘buy’ button 220, a buy request is sent to the trading module 107. On receiving the buy request, the trading module 107 queries the challenge module 108 to access and apply the reward to the buy request. For example, if the reward is an x % discount on the tag price 215, the trading module 107 generates an invoice at a discounted price for the user. Subsequently, the user may enter into a payment transaction.

In some embodiments, the plurality of challenge elements are configured in the form of clickable banner ads and sponsored links that can range from static graphical images to rich media content, permitting the user to click on the ad and be redirected to an electronic transaction website (either in a new browser window or a new tab in the user's browser) to display the product, describe the product, and provide a mechanism to either facilitate a purchase through that website or accept a challenge, prior to the purchase, to win a reward realizable on a subsequent online purchase.

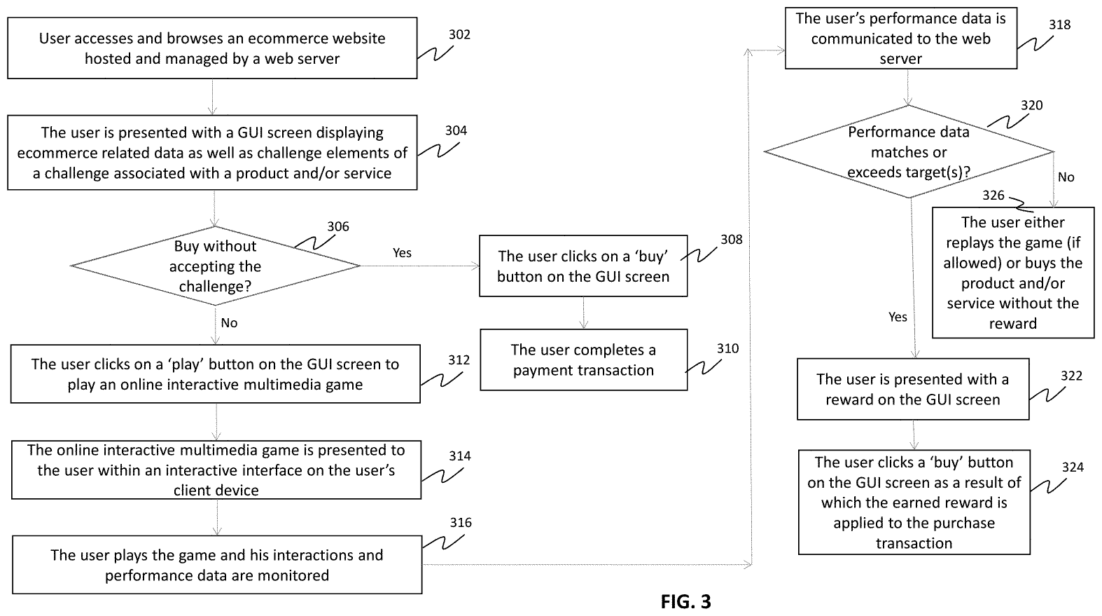

FIG. 3 is a flowchart illustrating an exemplary process for implementing an interactive multimedia challenge or advertisement in the context of an electronic transaction, in accordance with an embodiment of the present specification. The described process may be accomplished using some or all of the system components described in detail above and, in some implementations, various steps may be performed in different sequences and various steps may be omitted. Additional steps may be performed along with some or all of the steps shown in the depicted flow chart. One or more steps may be performed simultaneously. Accordingly, the steps as illustrated (and described in greater detail below) are exemplary by nature and, as such, should not be viewed as limiting.

Referring now to FIGS. 1 and 3, according to aspects of the present specification, at step 302, a user accesses (via the network 125) and browses an electronic transaction website hosted and managed by the web server 105. In some embodiments, the user is a registered member of the website and hence uniquely identifiable by way of a login ID. In embodiments, the web server 105 tracks the user's activities using the user's login ID and/or the IP (Internet Protocol) address of the client device 120 that the user uses to connect to the web server 105. In some embodiments, the electronic transaction website may be a software application residing on a user's device, for example, an application running on a user's personal computer, mobile phone, or video game console.

At step 304, as a result of the user's browsing of the website, the user is presented with a GUI screen (such as, for example, the screen 200 of FIG. 2A) that provides the user with electronic transaction related data as well as challenge elements of a challenge associated with a product and/or service. In some embodiments, the product and/or service are user-selected. In some embodiments, the challenge is configured as an advertisement that, if activated by the user (such as by clicking a ‘play’ button of the advertisement), allows the user to play an online interactive multimedia game—a successful completion of which would enable the user to realize a reward when buying the product and/or service.

At step 306, the user decides if he would like to buy the product and/or service without opting for the challenge or if he would like to accept the challenge. If the user decides to buy the product and/or service without accepting the challenge, then at step 308 the user clicks on a ‘buy’ button on the GUI screen and subsequently completes a payment transaction, at step 310, corresponding to the purchase of the product and/or service.

However, if the user decides to accept the challenge then, at step 312, the user clicks on a ‘play’ button on the GUI screen that connects the user to the game server 110 to enable the user to play an online interactive multimedia game. At step 314, the online interactive multimedia game is presented to the user within an interactive interface on the user's client device 120. As discussed earlier in this specification, the online interactive multimedia game may be rendered in any one of first, second or third interactive interface formats, wherein in the first format the game may be presented in an interface embedded within the GUI screen, wherein in the second format the game is presented as a multimedia playback using a media player native or residing on the client device 120 and wherein in the third format an executable program file is downloaded on the client device 120 which when activated presents an interface of a client-side gaming application. In some embodiments, the interactive multimedia game is a mini-game that can be played within a stipulated predetermined time frame.

At step 316, the user plays the game and his interactions and performance data are monitored by and communicated back to the game server 110 for storing in the game database system 130. In case of a disruption or a loss of connection on the network 125 between the client device 120 and the game server 110 during gameplay, the game server 110 may hold an existing gameplay state (status in abeyance), for a predefined period of time, which is also referred to as a ‘timeout’, while restoration of the connection is awaited. If the connection is not restored and the timeout period is exceeded, the game server 110 may end or void the gameplay. However, if the connection is restored within the timeout period, the user is allowed to resume gameplay from the state, status or situation that existed prior to the disruption or loss of connection. It should further be noted that in the third format where an executable program file is downloaded on the client device 120, the game is run locally on the client device 120 and the user's interaction and performance data may be uploaded to the game server 110 periodically and/or at the end of gameplay during a stable connection between the client device 120 and the game server 110.

At step 318, on completion of the game, the user's performance data is communicated to the web server 105. At step 320, the challenge module 108 determines if the performance data meets or exceeds one or more predetermined targets associated with the game. If the performance data meets or exceeds one or more predetermined targets then, at step 322, the user is presented with a communication that may include a reward on the GUI screen. It should be appreciated that, in some embodiments, the reward structure is binary—that is, the user is presented with a reward only if the performance data meets or exceeds one or more predefined thresholds. However, in alternate embodiments, the reward structure may be configured as a spectrum wherein the user may receive one of a spectrum of different rewards depending on the performance data. For example, if the user's performance data meets, e.g. 25% of the predefined threshold or target then the user may be presented with a predefined percentage, e.g. 25%, or amount of the reward that the user would have otherwise received if he had met 100% of the target. Thus, partial or different forms of rewards may accrue to the user at different percentages of targets met. In some embodiments, a range of different rewards is available to the user based on his performance data varying from x % to 100%, at incremental steps of y %, of the predefined threshold or target being met. In one embodiment, x ranges from 5% to 40%, and every increment therein, and y ranges from 1% to 10% and every increment therein.

At step 324, the user clicks the ‘buy’ button as a result of which the earned reward is applied to the purchase transaction. It should be appreciated that if the user does not buy the product and/or services then, in some embodiments, the user forfeits the reward. In alternate embodiments, the earned reward may remain active for the user, for a predetermined time period, during which if the user buys the product and/or service the earned reward is applied to the purchase transaction.

However, if the user's performance data falls short of the one or more predetermined targets then, at step 326 a message is displayed that the user did not win the reward and that he may either replay the game (if allowed, in some embodiments) for a predetermined number of attempts or buy the product and/or service without the reward.

The above examples are merely illustrative of the many applications of the methods and systems of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A computer implemented method for generating and executing online interactive multimedia challenges during electronic transactions, the method being implemented in a host computer having one or more physical processors programmed with computer program instructions that, when executed by the one or more physical processors, cause the host computer to perform the method, the method comprising:
providing an on-line advertisement comprising a first graphical user interface having a first option associated with a first purchase offer of a product or service and a second option associated with engaging in a challenge;
receiving, at the host computer, data indicative of whether the user selected the first option or the second option;
using the host computer, generating a plurality of second graphical user interfaces if the data is indicative of the user selecting the first option, wherein the plurality of second graphical user interfaces are configured to receive billing information and to complete a purchase transaction; and
using the host computer, generating a third graphical user interface comprising the challenge if the data is indicative of the user selecting the second option.

2. The computer implemented method of claim 1 further comprising monitoring the user's engagement with the challenge and generating a second purchase offer based on an outcome of said challenge, wherein the second purchase offer is different than the first purchase offer.

3. The computer implemented method of claim 1 wherein, using the host computer, the challenge is generated based on the user's browsing history.

4. The computer implemented method of claim 1 wherein, using the host computer, the challenge is generated based on the user's login ID.

5. The computer implemented method of claim 1 wherein the third graphical user interface challenge is configured as a downloadable executable that, if activated by the user, allows the user to engage with the challenge.

6. The computer implemented method of claim 1 wherein the third graphical user interface challenge is configured as a scripted advertisement that, if activated by the user, allows the user to engage with the challenge.

7. The computer implemented method of claim 1, further comprising, using the host computer, directing the user to a game server if the user interacts with the third graphical user interface.

8. The computer implemented method of claim 1, further comprising monitoring, by the host computer, the user's gameplay, interactions, and performance data and communicating the user's gameplay, interactions, and performance data to a game server for storing in a game database system.

9. The computer implemented method of claim 8, further comprising using a challenge module in the host computer, determining if the user's performance data meets or exceeds one or more predetermined targets associated with the challenge.

10. The computer implemented method of claim 9, further comprising, using the challenge module, determining that the performance data meets or exceeds one or more predetermined targets associated with the challenge and, in response, generating a second purchase offer, wherein the second purchase offer is different than the first purchase offer.

11. A system for generating and executing online interactive multimedia challenges during electronic transactions, said system comprising:
a host computer having one or more physical processors programmed with computer program instructions that, when executed, cause the host computer to:
provide an on-line advertisement comprising a first graphical user interface having a first option associated with a first purchase offer of a product or service and a second option associated with engaging in a challenge;
receive data indicative of whether the user selected the first option or the second option;
generate a plurality of second graphical user interfaces, wherein the plurality of second graphical user interfaces are configured to receive billing information and to complete a purchase transaction; and
generate a third graphical user interface comprising said challenge if the data is indicative of the user selecting the second option.

12. The system of claim 11 wherein, when executed, the computer program instructions further cause the host computer to monitor the user's engagement with the challenge and generate a second purchase offer based on an outcome of said challenge, wherein the second purchase offer is different than the first purchase offer.

13. The system of claim 11 wherein, when executed, the computer program instructions further cause the host computer to generate the challenge based on the user's browsing history.

14. The system of claim 11 wherein, when executed, the computer program instructions further cause the host computer to generate the challenge based on the user's login ID.

15. The system of claim 11 wherein the third graphical user interface challenge is configured as a downloadable executable that, if activated by the user, allows the user to engage with the challenge.

16. The system of claim 11 wherein the third graphical user interface challenge is configured as a scripted advertisement that, if activated by the user, allows the user to engage with the challenge.

17. The system of claim 11, wherein, when executed, the computer program instructions further cause the host computer to direct the user to a game server if the user interacts with the third graphical user interface.

18. The system of claim 11, wherein, when executed, the computer program instructions further cause the host computer to monitor the user's gameplay, interactions, and performance data and communicate the user's gameplay, interactions, and performance data to a game server for storing in a game database system.

19. The system of claim 18, wherein, when executed, the computer program instructions further cause the host computer to use a challenge module to determine if the user's performance data meets or exceeds one or more predetermined targets associated with the challenge.

20. The system of claim 19, wherein, when executed, the computer program instructions further cause the host computer to use the challenge module to determine that the performance data meets or exceeds one or more predetermined targets associated with the challenge and, in response, generate a second purchase offer, wherein the second purchase offer is different than the first purchase offer.
